(19) United States
(12) Patent Application Publication
(10) Pub. No.: US 2025/0313458 A1
(43) Pub. Date: Oct. 9, 2025

(54) PROCESSES FOR LOW CARBON INTENSITY HYDROGEN PRODUCTION

(71) Applicant: Chevron U.S.A. Inc., San Ramon, CA (US)

(72) Inventors: Christopher Declan Lane, Kensington, CA (US); Steven Xuqi Song, El Cerrito, CA (US); Huping Luo, Moraga, CA (US); Yaofan Yi, Hercules, CA (US); Bi-Zeng Zhan, Albany, CA (US); Trenton J. Otto, El Sobrante, CA (US); Howard Steven Lacheen, Richmond, CA (US)

(21) Appl. No.: 18/628,598

(22) Filed: Apr. 5, 2024

(51) Int. Cl. C01B 3/26; C10G 45/44

(52) U.S. Cl. CPC C01B 3/26; C10G 45/44; C01B 2203/065; C01B 2203/0838; C01B 2203/085; C01B 2203/1241; C01B 2203/84; C10G 2300/1096; C10G 2300/4006; C10G 2300/4012; C10G 2300/4037; C10G 2300/4043; C10G 2300/42

(57) ABSTRACT

A continuous process includes supplying, to a hydrogen production unit, an energy source in the form of mechanical energy or electrical energy produced from thermal energy generated in a hydrogenation process in a hydrogenation reactor unit, and flowing a light hydrocarbon feed stream into the hydrogen production unit in the presence of a catalyst to produce a hydrogen gas enriched stream using the energy source.

### BACKGROUND

Hydrogen is an important fuel for future clean energy. Storage and transportation of hydrogen fuel from its production location to, for example, a hydrogen fueling station or other storage facility are often energy inefficient and/or costly. Efficient hydrogen production and transportation are well recognized as a technical barrier for hydrogen deployment at commercial scale. The storage of hydrogen in liquid organic hydrogen carrier (LOHC) systems has numerous advantages over conventional storage systems (e.g., compression and liquefaction technologies). Most importantly, hydrogen storage and transport in the form of a LOHC system enables the use of existing infrastructure that transports liquid fuels. Hydrogen storage in a LOHC system requires a highly exothermic hydrogenation step and an endothermic dehydrogenation step (i.e., one which requires an input of heat, at a temperature where the dehydrogenation of the carrier can proceed with adequate reaction rates).

### SUMMARY

In accordance with an illustrative embodiment, a continuous process comprises:
supplying, to a hydrogen production unit, an energy source in the form of mechanical energy or electrical energy produced from thermal energy generated in a hydrogenation process in a hydrogenation reactor unit, and
flowing a light hydrocarbon feed stream into the hydrogen production unit in the presence of a catalyst to produce a hydrogen gas enriched stream using the energy source.

In accordance with another illustrative embodiment, a continuous process comprises:
hydrogenating, in a hydrogenation reactor unit, a liquid organic hydrogen carrier to a hydrogen-saturated liquid organic hydrogen carrier in the presence of a first hydrogen gas enriched stream and a hydrogenation catalyst,
converting thermal energy generated in the hydrogenation reactor unit to an energy source in the form of mechanical energy or electrical energy, and
supplying the energy source to a hydrogen production unit to convert a light hydrocarbon feed stream to a second hydrogen gas enriched stream.

### BRIEF DESCRIPTION OF THE DRAWINGS

In combination with the accompanying drawings and with reference to the following detailed description, the features, advantages, and other aspects of the implementations of the present disclosure will become more apparent, and several implementations of the present disclosure are illustrated herein by way of example but not limitation. The principles illustrated in the example embodiments of the drawings can be applied to alternative processes and apparatus. Additionally, the elements and features shown in the drawings are not necessarily to scale, emphasis is instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements. In the accompanying drawings:

FIG. 1 illustrates a process flow diagram describing an integrated system and process of a hydrogen production and transportation value-chain, according to an illustrative embodiment.

FIG. 2 illustrates a process flow diagram describing an organic Rankine cycle process, according to an illustrative embodiment.

FIG. 3 illustrates a process flow diagram of an exemplary system and process integrating hydrogen production, hydrogenation of a liquid organic hydrogen carrier, and an organic Rankine cycle, according to an illustrative embodiment.

### DETAILED DESCRIPTION

Various illustrative embodiments described herein are directed to systems and processes for producing hydrogen utilizing heat recovered from production of a hydrogen-saturated liquid organic hydrogen carrier in a hydrogen production and transportation value-chain.

Storage and transportation of hydrogen is a key enabling technology for the development of a hydrogen-based value-chain. Liquid organic hydrogen carriers (LOHC) are one of the various technologies in development for hydrogen transportation. As mentioned above, the storage and transportation of hydrogen fuel from its production location to its end user site are costly with current technology. Liquid organic hydrogen carriers are widely explored, such as toluene, benzyltoluene, dibenzyltoluene, N-ethylcarbozole, ammonia borane, ammonia, formic acid, siloxane, etc. The use of benzyltoluene and toluene as a LOHC carriers has gained significant interest recently.

Development of a zero carbon or low carbon intensity hydrogen value chain requires technologies that address challenges in hydrogen production and hydrogen transportation. The overall hydrogen value chain must be energy efficient to deliver the most cost-effective supply of hydrogen to the customer. In addition, if hydrogen is to play a role in the decarbonization of the energy sector and reduce the overall carbon footprint, the entire hydrogen production and transportation value chain must minimize greenhouse gas emissions and therefore emissions of carbon dioxide (CO₂) from production and transportation processes.

Currently, most of the hydrogen produced globally is by steam methane reforming (SMR) without carbon capture, which can produce on the order of 9 to 11 kg of CO₂ (lifecycle basis) per kg of hydrogen product. If there is carbon capture, then the hydrogen can be produced on the order of 3 to 5 kg of CO₂ per kg of hydrogen product. All numbers are based on the 2022 GREET model from Argonne National Lab. There are other technologies which are currently in development such as, for example, methane catalytic cracking, electrified Steam Methane Reforming (eSMR), Autothermal Reforming (ATR), and electrolysis, that produce hydrogen from natural gas (with the exception of water electrolysis) and have the advantage of producing hydrogen with significantly lower or zero direct CO₂ emissions. Of these technologies, methane pyrolysis and electrolysis do not produce CO₂ as a direct byproduct of the reaction chemistry, however, they require significant energy input via either heat or electricity.

Current commercial processes, adapted from aromatic saturation processes are not optimized for use in the hydrogen value chain. Additionally, since the hydrogenation of toluene to methylcyclohexane (or benzyltoluene to perhydro-benzyltoluene) is a highly exothermic process, the recovery and utilization of the reaction heat is important to overall process economics. At commercial scale, the total heat produced from the toluene hydrogenation process is significant thereby potentially justifying additional CAPEX (Capital Expenses) for heat recovery that is not viable in smaller scale operations or for hydrogenation processes with lower overall reaction exotherms.

The non-limiting illustrative embodiments described herein overcome the drawbacks discussed above by providing systems and processes for an optimized heat recovery and utilization process directed to the production of a hydrogen-saturated liquid organic hydrogen carrier. By employing the integrated system and process of optimized heat recovery and utilization thereof in the non-limiting illustrative embodiments described herein, energy is conserved within the hydrogen production and transportation value-chain. The integrated system and process exploits the exothermic nature of the LOHC hydrogenation process and endothermic nature of the hydrogen production process to recover heat from LOHC hydrogenation, transform it to mechanical work and/or electricity through a Rankine cycle process and utilize the recovered energy in the hydrogen production process. Accordingly, overall heat utilization is improved together with energy efficiency and reduced carbon emissions which are all important technical challenges in the development of the hydrogen value-chain. The integrated system and process therefore improves overall system economics by reducing the integrated process energy requirements thereby offsetting potential CO₂ emissions.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology can be applied, as long as that definition does not conflict with any other disclosure or definition applied herein or render indefinite or non-enabled any claim to which that definition is applied. To the extent that any definition or usage provided by any document incorporated herein by reference conflicts with the definition or usage provided herein, the definition or usage provided herein controls.

While systems and processes are described in terms of “comprising” various components or steps, the systems and processes can also “consist essentially of” or “consist of” the various components or steps, unless stated otherwise.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

The term “continuous” as used herein shall be understood to mean a system that operates without interruption or cessation for a period of time, such as where reactant(s) and catalyst(s) are continually fed into a reaction zone and products are continually or regularly withdrawn without stopping the reaction in the reaction zone.

The term “catalyst” means a substance that alters the rate of a chemical reaction. A catalyst may either increase the chemical reaction rate (i.e., a “positive catalyst”) or decrease the reaction rate (i.e., a “negative catalyst”). Catalysts participate in a reaction in a cyclic fashion such that the catalyst is cyclically regenerated. “Catalytic” means having the properties of a catalyst.

The term “carrier” or “support” interchangeably refers to conventional materials that are typically a solid with a high surface area, to which catalyst materials are affixed. Support materials may be inert or participate in the catalytic reactions and may be porous or non-porous.

The term “noble metal” refers to metals that are highly resistant to corrosion and/or oxidation. Group VIII noble metals include ruthenium (Ru), osmium (Os), rhodium (Rh), iridium (Ir), palladium (Pd), and platinum (Pt).

The terms “benzyltoluene” and “dibenzyltoluene” include isomers of the compounds mentioned. In addition, the terms benzyltoluene and dibenzyltoluene also include substituted benzyl- or dibenzyltoluenes in which one or both benzyl groups are substituted by one or more groups selected from alkyl groups, such as methyl or ethyl groups, aryl groups, such as phenyl groups, and heteroaryl groups, such as pyridinyl groups.

The terms “wt. %”, “vol. %”, or “mol. %” refer to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of the component.

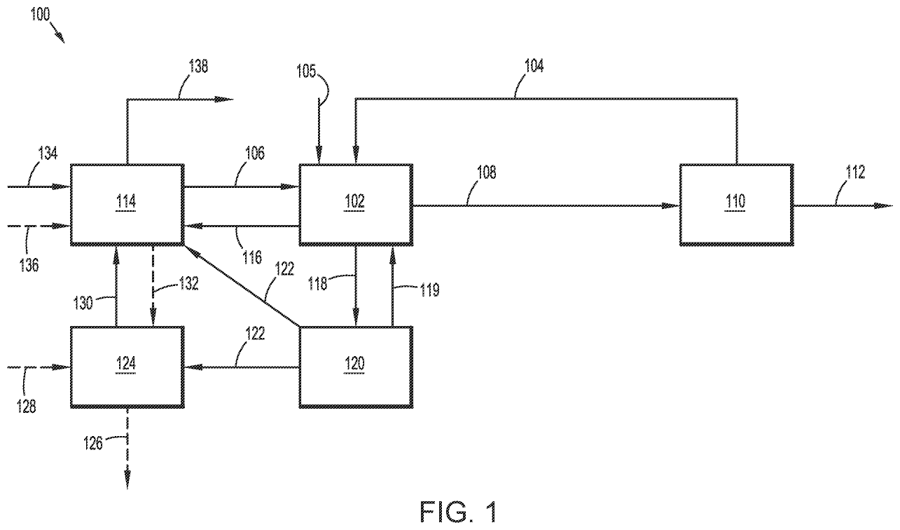

The non-limiting illustrative embodiments of the present disclosure will be specifically described below with reference to the accompanying drawings. The non-limiting illustrative embodiments disclosed herein of FIGS. 1-3 utilize a heat integration design for recovering heat from the production of a hydrogen-saturated liquid organic hydrogen carrier to, for example, offset energy demand of the hydrogen production process and associated greenhouse gas emissions of the hydrogen production process either though mechanical shaft work or electrical energy. For the purpose of clarity, some steps leading up to the production of hydrogen as illustrated in FIGS. 1-3 may be omitted. In other words, one or more well-known processing steps which are not illustrated but are well-known to those of ordinary skill in the art have not been included in the figures. This is not intended to be interpreted as a limitation of any particular embodiment, or illustration, or scope of the claims.

FIG. 1 illustrates a system and process diagram for recovering heat from the production of a hydrogen-saturated liquid organic hydrogen carrier, according to a non-limiting illustrative embodiment. Referring now to FIG. 1, a system 100 includes a hydrogenation system 102 for hydrogenating a liquid organic hydrogen carrier stream 104 or a liquid organic hydrogen carrier stream 105 in the presence of a hydrogen gas enriched stream effluent 106. As one skilled in the art will readily appreciate, hydrogenation system 102 can receive a liquid organic hydrogen carrier stream in the form of a dehydrogenated liquid organic hydrogen carrier stream, referred to as liquid organic hydrogen carrier stream 104 received from a dehydrogenation reactor unit 110 as discussed below and/or from a storage tank, a fresh liquid organic hydrogen carrier stream, referred to as liquid organic hydrogen carrier stream 105, received from, for example, a storage tank, or both can be used.

Suitable liquid organic hydrogen carriers include, for example, aromatic hydrocarbon compounds which are converted into the respective saturated hydrocarbon compounds in a catalytic hydrogenation. Representative examples of aromatic hydrocarbon compounds include, but are not limited to, monoaromatic compounds, polyaromatic compounds, isomeric mixtures thereof and the like. Suitable aromatic compounds include, for example, toluene, benzyltoluene, alkylbenzenes, naphthalene, alkylnaphthalenes, anthracene, and diphenylethane. In some embodiments, alkylbenzenes include a compound in which 1 to 4 hydrogen atoms in the aromatic ring are substituted with a linear alkyl group or a branched alkyl group having 1 to 6 carbon atoms. Suitable alkylbenzenes for use herein include, for example, toluene, xylene, mesitylene, ethylbenzene, and diethylbenzene. Alkylnaphthalenes include a compound in which 1 to 4 hydrogen atoms in the aromatic ring are substituted with a linear alkyl group or a branched alkyl group having 1 to 6 carbon atoms. Examples of such a compound include methylnaphthalene. These compounds may be used alone or in combination.

In some embodiments, liquid organic hydrogen carrier stream 104 and liquid organic hydrogen carrier stream 105 are toluene. In some embodiments, liquid organic hydrogen carrier stream 104 and liquid organic hydrogen carrier stream 105 are benzyltoluene.

In a non-limiting embodiment, when the liquid organic hydrogen carrier stream is toluene, the hydrogenation process can produce methylcyclohexane. In another non-limiting embodiment, when the liquid organic hydrogen carrier stream is benzyltoluene (0H-BT), the hydrogenation process can produce perhydro-benzyltoluene (12H-BT), and there may be a relatively small amount of intermediate products. A generalized reaction pathway for the hydrogenation process of toluene and benzyltoluene is illustrated below in respective Scheme I and Scheme II. For the sake of simplicity, for the hydrogenation process illustrated for benzyltoluene, only the meta isomer of benzyltoluene (1-benzyl-2-methylbenzene) is shown, however it is understood that benzyltoluene may have an isomer composition of, for example, 50% para (1-benzyl-4-methylbenzene), 45% meta isomer (1-benzyl-4-methylbenzene), and 5% ortho isomer (1-benzyl-3-methylbenzene).

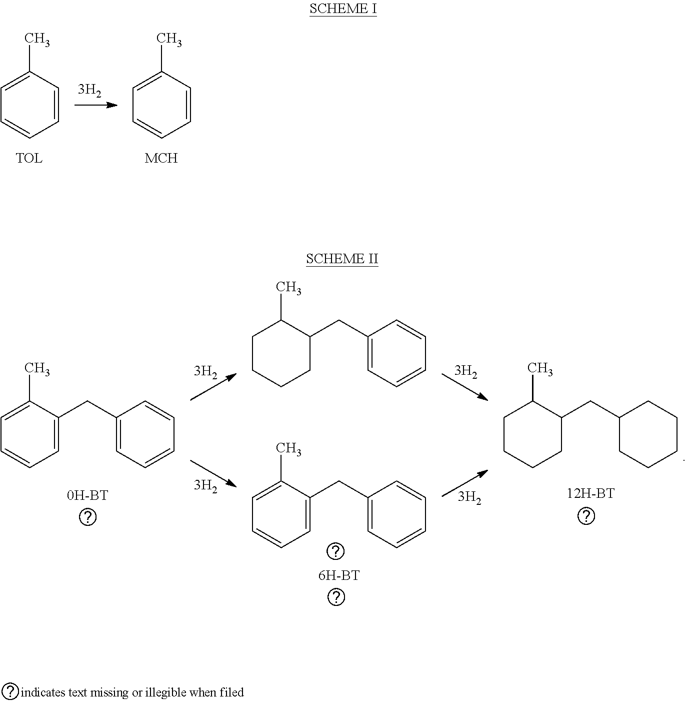

Hydrogen gas enriched stream effluent 106 is received from a hydrogen production unit 114 as discussed below. In some embodiments, hydrogen gas enriched stream effluent 106 can contain at least hydrogen and methane. In some embodiments, hydrogen gas enriched stream effluent 106 can contain at least about 70 vol. % hydrogen, or at least about 90 vol. % hydrogen. In some embodiments, when hydrogen gas enriched stream effluent is derived from natural gas, hydrogen gas enriched stream effluent 106 can contain at least about 80 vol. % hydrogen and up to about 99 vol. % hydrogen, and about 20 vol. % unreacted natural gas and up to about 1 vol. % unreacted natural gas.

The hydrogenation process may be accomplished by any means that generates a hydrogen-saturated liquid organic hydrogen carrier 108. In an embodiment, liquid organic hydrogen carrier stream 104 and/or liquid organic hydrogen carrier stream 105 can be hydrogenated by reaction with hydrogen gas enriched stream effluent 106 in the presence of a hydrogenation catalyst at hydrogenation reaction conditions capable of forming hydrogen-saturated liquid organic hydrogen carrier 108. In some embodiments, the hydrogenation catalyst can comprise a supported Group VIII (noble) metal. In some embodiments, the hydrogenation catalyst can be a catalyst material typically consisting of a metallic oxide support upon which active metals are dispersed. In some embodiments, the active metals include, for example, Group VIII (noble) metals and/or transition metals such as Ni, Pt, Re and Pd, and the inert oxide support includes, for example, titanium dioxide (TiO₂) or aluminum oxide (Al₂O₃). In some embodiments, the hydrogenation catalyst can be a catalyst material consisting of a non-metallic oxide support upon which active metals are dispersed, such as carbon and SiO₂ supports. As one skilled in the art will understand, the hydrogenation catalyst described above is merely illustrative, any suitable hydrogenation catalyst can be used herein.

The quantity of the hydrogenation catalyst utilized can be dependent upon the identity of the hydrogenation catalyst and the particular hydrogenation process utilized. Generally, the amount of hydrogenation catalyst used can be any amount which can produce the desired hydrogen-saturated liquid organic hydrogen carrier 108. For example, in some embodiments, the amount of hydrogenation catalyst used in the hydrogenation process can range from about 0.1 h⁻¹ to 10 h⁻¹ liquid hourly space velocity, based upon the total volume of the hydrogenation catalyst with an active metal loading of about 0.5 wt. % and the flow rate of the liquid organic hydrogen carrier stream 104.

Suitable hydrogenation conditions for hydrogenating liquid organic hydrogen carrier stream 104 can comprise a hydrogen pressure, a temperature, a contact time, or any combination thereof. In some embodiments, the temperature of the hydrogenation process can range from about 400° F. to about 700° F. In some embodiments, the temperature of the hydrogenation process can range from about 200 psi-g to about 1500 psi-g. In some embodiments, the temperature of the hydrogenation process can range from about 300 psi-g to about 600 psi-g. In a non-limiting illustrative embodiment, the temperature of the feed mixture comprising liquid organic hydrogen carrier stream 104 and hydrogen gas enriched stream effluent 106 is raised to about 450° F. at the entrance to hydrogenation system 102. The reaction is highly exothermic, and the outlet temperature of hydrogenation system 102 can range from about 480° F. to about 550° F. In some embodiments, the ratio of hydrogen gas enriched stream effluent 106 to liquid organic hydrogen carrier stream 104 and/or liquid organic hydrogen carrier stream 105 can range from about 2000 scf/bbl to about 10,000 scf/bbl.

In some embodiments, when two or more hydrogenation reactor units are employed, additional hydrogen can be added to the second and subsequent reactors if needed to compensate for the hydrogen consumption in the hydrogenation reaction carried out in the first hydrogenation reactor unit. Alternatively, in a single reaction vessel, additional hydrogen can be added between catalyst beds through a set of inter-bed reactor internals, to make up the hydrogen consumption and provide quench to the process stream.

Generally, the hydrogenation process can be performed in any type of process which can hydrogenate a liquid organic hydrogen carrier to form hydrogen-saturated liquid organic hydrogen carrier 108. In an embodiment, the hydrogenation process can be performed in a batch process, a continuous process; or any combination thereof.

In some embodiments, hydrogenation system 102 includes at least one or more hydrogenation reactor units and one or more heat exchangers. Suitable hydrogenation reactor units include, for example, a slurry reactor, a continuous stirred tank reactor, a fixed bed reactor, or any combination thereof. In some embodiments, the hydrogenation process can be carried out in two hydrogenation reactor units in series. However, the number and type of reactor is not limited and any number and types of reactors can be used. For example, the hydrogenation process can be carried out in three, four, or more hydrogenation reactor units in series.

In operation, liquid organic hydrogen carrier stream 104 and/or liquid organic hydrogen carrier stream 105 and hydrogen gas enriched stream effluent 106 are fluidly connected with hydrogenation system 102, and configured for the introduction of liquid organic hydrogen carrier stream 104 and/or liquid organic hydrogen carrier stream 105 comprising an aromatic hydrocarbon to be hydrogenated thereto by hydrogen gas enriched stream effluent 106 to generate hydrogen-saturated liquid organic hydrogen carrier 108. One or more pumps can be utilized in hydrogenation system 102 to assist in the flow of liquid organic hydrogen carrier stream 104 and/or liquid organic hydrogen carrier stream 105 and hydrogen gas enriched stream effluent 106 through hydrogenation system 102. For example, a pump can be fluidly connected with one or more heat exchangers (not shown). In some embodiments, suitable heat exchangers include, for example, a tube-in-shell, plate-in-frame, microchannel, spiral wound, or any other suitable heat exchanger.

In another embodiment, a hydrogenation reaction process in hydrogenation system 102 may be intensified when the reaction vessel is integrated with the heat exchanger. The reactor may be designed in such a way that the heat from the hydrogenation process is directly removed by a circulating heat transfer fluid (e.g., a heat exchange fluid 119).

Since the hydrogenation process is highly exothermic, the one or more heat exchangers are configured to deliver the thermal energy (i.e., excess heat) and reduce the temperature of hydrogen-saturated liquid organic hydrogen carrier 108 introduced thereto, via heat exchange to a heat exchange fluid to generate a heated heat exchange fluid 118. The thermal energy carried by heated heat exchange fluid 118 can then be delivered to a thermodynamic cycle which converts the thermal energy into mechanical energy, which can then subsequently be converted into electric energy. In some embodiments, heated heat exchange fluid 118 will take part in an organic Rankine cycle process in an organic Rankine cycle system 120 in system 100 for converting the thermal energy generated during the hydrogenation process to one of mechanical energy or electrical energy as discussed below. In some embodiments, the excess heat from the hydrogenation process is recovered and transformed to increase its utility at a gross efficiency of about 10% to about 35%, or from about 20% to about 30%, or from about 24% to about 28%.

In some embodiments, greater than about 80 wt. % of liquid organic hydrogen carrier stream 104 and/or liquid organic hydrogen carrier stream 105 will be converted to hydrogen-saturated liquid organic hydrogen carrier 108. In some embodiments, greater than about 90 wt. % of liquid organic hydrogen carrier stream 104 and/or liquid organic hydrogen carrier stream 105 will be converted to hydrogen-saturated liquid organic hydrogen carrier 108. In some embodiments, greater than about 95 wt. % of liquid organic hydrogen carrier stream 104 and/or liquid organic hydrogen carrier stream 105 will be converted to hydrogen-saturated liquid organic hydrogen carrier 108. In some embodiments, greater than or equal to about 99 wt. % of liquid organic hydrogen carrier stream 104 and/or liquid organic hydrogen carrier stream 105 will be converted to hydrogen-saturated liquid organic hydrogen carrier 108. In some embodiments, greater than or equal to about 99.5 wt. % of liquid organic hydrogen carrier stream 104 and/or liquid organic hydrogen carrier stream 105 will be converted to hydrogen-saturated liquid organic hydrogen carrier 108.

The hydrogenation process further generates methane enriched stream 116 from hydrogen gas enriched stream effluent 106. Methane enriched stream 116 is then sent back to hydrogen production unit 114 for further processing as discussed below.

Following completion of the hydrogenation process, hydrogen-saturated liquid organic hydrogen carrier 108 is sent to a dehydrogenation reactor unit 110 to dehydrogenate hydrogen-saturated liquid organic hydrogen carrier 108. For example, hydrogen-saturated liquid organic hydrogen carrier 108 can be dehydrogenated by methods well known in the art to generate a hydrogen-rich stream 112 and liquid organic hydrogen carrier stream 104.

In an illustrative embodiment, hydrogen-saturated liquid organic hydrogen carrier 108 can be contacted with a catalytic composite in dehydrogenation reactor unit 110 under dehydrogenation conditions. Suitable dehydrogenation reactor units include, for example, a fixed catalyst bed system, a moving catalyst bed system, a fluidized bed system, or in a batch-type operation. The dehydrogenation reactor unit itself may comprise one or more separate reactor zones with heating means therebetween to ensure that the temperature can be maintained at the entrance to each reaction zone to obtain the desired conversion. Hydrogen-saturated liquid organic hydrogen carrier 108 may be contacted with the catalyst composite in either upward, downward or radial flow fashion.

Dehydrogenation conditions vary and may include a temperature of from about 450° F. to about 675° F., and a pressure of from about 101 kPa to about 445 kPa.

If desired, hydrogen-saturated liquid organic hydrogen carrier 108 may be admixed with a diluent gas before, while or after being passed to the dehydrogenation zone. The diluent material may be hydrogen, steam, methane, natural gas, carbon dioxide, nitrogen, argon and the like, or a mixture thereof. The diluent hydrogen stream passed to the dehydrogenation zone will typically be recycled after hydrogen is separated from the effluent of the dehydrogenation zone in the hydrogen separation zone.

The dehydrogenation catalyst composite may exhibit high activity, high selectivity and good stability. Dehydrogenation catalysts may be the same as or different from the hydrogenation catalysts described above.

The dehydrogenation of hydrogen-saturated liquid organic hydrogen carrier 108 yields hydrogen and unreacted components and a dehydrogenated liquid organic hydrogen carrier. The hydrogen and unreacted components are separated from the dehydrogenated liquid organic hydrogen carrier and exit dehydrogenation reactor unit 110 as a hydrogen-rich stream 112 where it can be stored or sent for further use or processing. The resulting liquid organic hydrogen carrier stream 104 in dehydrogenated form may be recycled and reused in hydrogenation system 102 as described above.

System 100 further includes organic Rankine cycle system 120. Organic Rankine cycle system 120 is part of hydrogenation system 102, and utilizes heated heat exchange fluid 118 from hydrogenation system 102. As discussed above, since the hydrogenation process is an exothermic reaction, the thermal energy generated by the hydrogenation process in hydrogenation system 102 is transferred to heated heat exchange fluid 118 and takes part in an organic Rankine cycle process in organic Rankine cycle system 120 where it is converted to one of mechanical shaft work and/or electricity 122. Such mechanical shaft work and/or electricity 122 can, in turn, be used to power ancillary components associated with system 100, such as a heat production system 124 to generate heat for hydrogen production unit 114. In some embodiments, mechanical shaft work and/or electricity 122 can be used to offset the mechanical and/or electrical energy used in the hydrogen production process in hydrogen production unit 114. For example, this can reduce the required mechanical shaft work and/or electricity input to be generated by other external means, such as conventional grid-generated power or renewable (e.g., solar or wind) power generated locally or remotely. Also, by utilizing the organic Rankine cycle process in the systems and processes of the illustrative embodiments described herein, a zero carbon or low carbon intensity can be achieved.

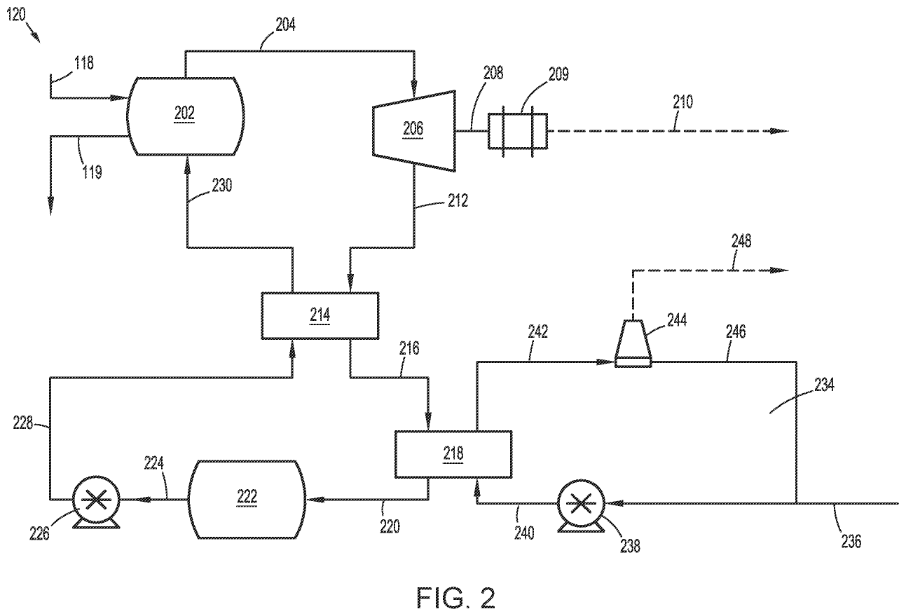

Any suitable organic Rankine cycle system capable of converting heat from the hydrogenation process to mechanical shaft work and/or electricity can be used as organic Rankine cycle system 120. In a non-limiting illustrative embodiment, FIG. 2 illustrates an exemplary organic Rankine cycle system that can be used as organic Rankine cycle system 120 in system 100 of FIG. 1. However, it is to be understood that the organic Rankine cycle system used as organic Rankine cycle system 120 in system 100 of FIG. 1 is merely illustrative and any other known or later developed organic Rankine cycle system is contemplated herein.

In the embodiment of FIG. 2, organic Rankine cycle system 120 comprises a circuit including at least a boiler 202 and a turbine 206. The organic Rankine cycle principle is based on a thermodynamic cycle to transform thermal energy into mechanical energy and, if desired, into electric energy through, for example, an electrical generator. Instead of generating steam from water, the organic Rankine cycle system vaporizes a working fluid, characterized by a molecular mass higher than that of water, which leads to a slower rotation of a turbine, lower pressures and causes no erosion of the metal parts and blades.

Boiler 202 receives incoming heated heat exchanger fluid 118 from hydrogenation system 102 and a heated pressurized working fluid 230 which circulates through organic Rankine cycle system 120 as discussed below. Boiler 202 can be a hydrogenation reactor unit as part of hydrogenation system 102. In some embodiments, suitable working fluids to circulate through organic Rankine cycle system 120 include, for example, toluene, benzyltoluene or methylcyclohexane, which is the feed or product of the hydrogenation process discussed above. By utilizing one of the feed or product of the hydrogenation process for both the hydrogenation and organic Rankine cycle processes, the CAPEX costs associated with the organic Rankine cycle working fluid can be reduced or eliminated thereby improving the overall process economics. In some embodiments, suitable working fluids to circulate through organic Rankine cycle system 120 include, for example, benzene, ethanol, methanol, propanone, cyclopentane and hexane. Upon entering boiler 202, heated heat exchanger fluid 118 transfers heat and vaporizes heated pressurized working fluid 230 to produce a first working fluid vapor 204. In addition, the transfer of heat from heated heat exchanger fluid 118 produces a heat exchange fluid 119 that has a temperature lower than the temperature of heated heat exchanger fluid 118. Heat exchange fluid 119 is then sent back to hydrogenation system 102 as shown in FIG. 1.

Organic Rankine cycle system 120 further includes turbine 206 for receiving first working fluid vapor 204 from boiler 202. Turbine 206 is driven by first working fluid vapor 204 and turns a shaft, or a gear or other driving mechanism, that generates mechanical energy 208 from the turbine 206 connected with a generator 209. Generator 209, if used, in turn converts mechanical energy 208 to electrical energy 210. In general, turbine 206 can only transform a portion of the energy from first working fluid vapor 204 to mechanical energy based on the thermodynamic properties of first working fluid vapor 204 and efficiency of turbine 206. Thus, a second working fluid vapor 212 having a lower pressure and temperature than first working fluid vapor 204 will be generated from turbine 206.

In some embodiments, first working fluid vapor 204 spins turbine 206 which rotates a shaft and creates mechanical energy 208. Mechanical energy 208 can then be converted to electrical energy 210 (i.e., electricity) by generator 209 (e.g., a shaft driven power generator). As will be discussed below, either of mechanical energy 208 or electrical energy 210 (which is referred to collectively as mechanical shaft work and/or electricity 122 in FIG. 1) can be sent to heat production system 124 (see FIG. 1). In some embodiments, either of mechanical energy 208 or electrical energy 210 can be sent to hydrogen production unit 114 to offset energy used in the hydrogen production process. In addition, if desired, a portion of electrical energy 210, if generated, can be sold to an electrical grid.

Organic Rankine cycle system 120 further includes a regeneration unit 214 for receiving second working fluid vapor 212 and a pressurized liquid cooled working fluid 228 from a pump 226 as discussed below. Suitable regenerators for regeneration unit 214 includes, for example, a heat exchanger. Second working fluid vapor 212 serves as a heat transfer medium to transfer heat to a pressurized liquid cooled working fluid 228 to generate heated pressurized working fluid 230 having a temperature greater than the temperature of pressurized liquid cooled working fluid 228. Second working fluid vapor 212 is likewise cooled by pressurized liquid cooled working fluid 228 to generate a cooled working fluid 216 having a temperature lower than the temperature of second working fluid vapor 212. In some embodiments, a heat exchanger may be a tube-in-shell, plate-in-frame, microchannel, spiral wound, or any other suitable heat exchanger.

Organic Rankine cycle system 120 further includes a condenser 218. Condenser 218 is configured to receive cooled working fluid 216 that is output from regeneration unit 214, and to cool and condense cooled working fluid 216 into a liquid working fluid 220 through the use of a heat exchanger cooled by a pressurized seawater stream 240 from a seawater system 234 discussed below. In some embodiments, where cooled working fluid 216 leaving from regeneration unit 214 and received by condenser 218 is in a mixed state of both gas and liquid, the amount of energy used by condenser 218 may be reduced, as less work may be required to condense cooled working fluid 216 to a liquid state.

Organic Rankine cycle system 120 further includes a buffer tank 222 for receiving liquid working fluid 220 to continuously circulate through organic Rankine cycle system 120. Buffer tank 222 can receive fresh working fluid if necessary (not shown). Once received in buffer tank 222, liquid working fluid 220 exits buffer tank 222 as a liquid working fluid 224 with or without fresh working fluid. As one skilled in the art can appreciate, if it is desired to change the working fluid to a different working fluid depending on the hydrogenation process discussed above, it may be advantageous to drain buffer tank 222 of its existing working fluid as well as remove liquid working fluid 220 from organic Rankine cycle system 120.

Organic Rankine cycle system 120 further includes a pump 226 for receiving liquid working fluid 224 having a first pressure. Pump 226 can be any suitable pump for increasing the pressure of liquid working fluid 224 to generate pressurized liquid cooled working fluid 228 having a second pressure greater than the first pressure. Pressurized liquid cooled working fluid 228 is then sent to regeneration unit 214 as discussed above.

Organic Rankine cycle system 120 further includes a seawater system 234 for cooling cooled working fluid 216 in one or more condensers 218 as discussed above. In the context of FIG. 1, system 100 contains hydrogen production unit 114 for receiving a light hydrocarbon feed stream 134 for processing as discussed below. Light hydrocarbon feed stream 134 can be, for example a natural gas stream which can be produced at a natural gas plant. As one skilled in the art will readily appreciate, a natural gas plant can be located near seawater such as the Gulf of Mexico or the Indian Ocean. Accordingly, it would be advantageous for system 100 to be located near the natural gas plant to receive the natural gas produced in the plant, infrastructure for shipping hydrogen-saturated liquid organic hydrogen carrier 108, as well as to utilize the fresh seawater from the seawater in seawater system 234 of organic Rankine cycle system 120. However, using seawater system 234 to cool cooled working fluid 216 is merely illustrative and any suitable cooling system, e.g., air cooling, is contemplated herein.

In operation, seawater system 234 is a closed loop system wherein seawater continuously flows through seawater system 234. If necessary, optional fresh seawater stream 236 can be added to the seawater system 234. A recirculated seawater stream 246 and optional fresh seawater stream 236 are sent to a pump 238. Pump 238 can be any suitable pump for increasing the pressure of recirculated seawater stream 246 and optional fresh seawater stream 236 to generate a pressurized seawater stream 240. For example, pump 238 may be a rotary pump including an impeller, or alternatively may be any other suitable fluid pump. Pressurized seawater stream 240 is then sent to condenser 218 as discussed above. Upon exiting condenser 218, a seawater stream 242 is sent to a heat rejection unit 244. In some embodiments, if seawater stream 242 is not at a temperature suitable to be sent to its original destination then it will flow from heat rejection unit 244 as recirculated seawater stream 246 where it can be combined with optional fresh seawater stream 236. If seawater stream 242 is at a temperature suitable to be sent to its original destination then it will flow from heat rejection unit 244 to the original destination as a seawater stream 248. Generally, as stated above, a natural gas plant can be located near seawater such as the Gulf of Mexico or Indian Ocean. Thus, for purposes of this example, the temperature suitable for seawater stream 242 to flow back into the Gulf of Mexico or the Indian Ocean can be, for example, 65° F. or lower.

Turning back to FIG. 1, in some embodiments, mechanical shaft work and/or electricity 122 can be sent to heat production system 124 in system 100 where it is utilized to generate a heated stream 130 to send to hydrogen production unit 114. Also, as discussed above, in some embodiments, mechanical shaft work and/or electricity 122 can be sent hydrogen production unit 114 to offset the mechanical or electrical energy used from external sources to convert the light hydrocarbon feed stream to a hydrogen gas enriched stream effluent and other chemical components as discussed below. Any suitable heat production process for heat production through direct transformation of mechanical shaft work and/or electricity 122 can be utilized in heat production system 124. In some embodiments, the heat production process may occur by, for example, resistance heating, induction heating, electric arc heating, or dielectric heating.

In some embodiments, heat production system 124 can be a combustion unit where the heat production process includes combustion of carbon-based reaction products with purified oxygen (oxy-fuel combustion). In an illustrative embodiment, electricity from mechanical shaft work and/or electricity 122 is utilized for direct heating of light hydrocarbons in a pyrolysis reactor by an electrical heating system in heat production system 124. The electrical heating system utilizes resistance type heating elements (e.g., silica carbide resistive heating elements) to produce a heated stream 130 for the reaction in a pyrolysis reactor as part of the hydrogen production process in hydrogen production unit 114. A carbon product is separated and removed from the hydrogen production process as carbon product stream 138.

In some embodiments, mechanical shaft work and/or electricity 122 is utilized in an air separation unit (not shown) to generate high purity oxygen. The high purity oxygen is then introduced to the combustion unit as an oxidizing source to combust a carbon-based fuel, for example, coke 132 produced from the hydrogen production process in hydrogen production unit 114 as discussed below to generate heated stream 130 and a concentrated CO₂ stream 126. In some embodiments, an oxidizing stream 128 such as air can be introduced to heat production system 124 to assist in the combustion of carbon-based reaction products. In this process, water may also be produced if the carbon-based fuel contains hydrogen. Concentrated CO₂ stream 126 is subsequently compressed and sequestered. Mechanical shaft work and/or electricity 122 may also be supplied for compression and further treatment and handling of the concentrated CO₂ stream 126. Sequestration may occur local to the natural gas supply in some embodiments.

In some embodiments, coke can be part of a catalyst utilized in the hydrogen production process in hydrogen production unit 114 (e.g., catalyst contains deposited coke) and the catalyst comprising coke particles is circulated between a reaction chamber of the hydrogen producing reaction and a regeneration chamber and a catalyst regeneration process in heat production system 124. The catalyst can contain deposited coke with sufficient loading to provide the necessary heat for the reaction after combustion is carried out. As one skilled in the art would understand, the catalyst is sent a regeneration unit where it is regenerated by burning the coke with an oxidizing stream such as a stream of purified oxygen or a mixture of oxygen and steam produced by mechanical shaft work and/or electricity 122 as discussed above. In some embodiments, oxidizing stream 128 such as air can be introduced to heat production system 124 to assist in the combustion. The gas-solid mixture is heated, and the catalyst is returned to the reaction chamber, thereby supplying heat for the hydrogen production process such as a pyrolysis reaction to proceed. Any flue gas is separated from the catalyst and removed from the process, where the flue gas is low in nitrogen and therefore separation and purification of the CO₂ is more efficient.

In some embodiments, the heat production process is carried out using traditional fuels such as natural gas and the like and the mechanical shaft work and/or electricity 122 is utilized by a carbon-capture, utilization, and storage (CCUS) process to produce heated stream 130.

System 100 further includes hydrogen production unit 114 which is configured to receive light hydrocarbon feed stream 134 and optionally water stream 136 to convert light hydrocarbon feed stream 134 to at least hydrogen gas enriched stream effluent 106 in the presence of a catalyst. In some embodiments, light hydrocarbon feed stream 134 can be comprised of primarily C₁-C₃ alkanes. The C₁-C₃ alkanes are not particularly limited and may include, for example, natural gas, methane, ethane, propane, and mixtures thereof. As used herein, natural gas comprises methane and potentially higher alkanes, carbon dioxide, nitrogen or other gases, and/or sulfide compounds such as hydrogen sulfide, and mixtures thereof. In illustrative embodiments, the light hydrocarbon feed may further contain a portion of the produced products that are recycled back to the light hydrocarbon feed along with unreacted methane. The produced product typically comprises a C₂ to C₁₀ hydrocarbon product and hydrogen. The C₂ to C₁₀ hydrocarbon product is not particularly limited and can be, for example, saturated, unsaturated, aromatic, or a mixture of such compounds. Examples of aromatic hydrocarbons include benzene, toluene, xylene, naphthalene, and methylnaphthalene. In some embodiments the C₂ to C₁₀ hydrocarbon product may comprise ethylene, propylene, acetylene, benzene, naphthalene, and various mixtures thereof depending upon the desired products and reactions used. In addition, as one skilled in the art will readily appreciate, the resulting C₂ to C₁₀ hydrocarbon product can be one of a liquid C₂ to C₁₀ hydrocarbon product or a solid C₂ to C₁₀ hydrocarbon product depending on the particular methane conversion process.

In an illustrative embodiment, the catalyst for use in the illustrative embodiments described herein can be a metal oxide catalyst on an oxide support. Suitable metals of the metal oxide include, for example, Na, K, Mg, Ca, Sr, Cr, Mo, Mn, Fe, Co, Ni, Cu, Zn, Ti, Al, rare earth metals, or a mixture thereof. In an illustrative embodiment, the metal oxide can be present in an amount ranging from about 0.01 to about 10 wt. %. In an illustrative embodiment, a suitable oxide support can be any suitable inorganic oxide support. Representative examples of such suitable oxide supports include, but are not limited to, alumina, silica, silica-alumina, titania, zirconia, or a mixture thereof. In one embodiment, the oxide support is one of alumina and silica-alumina where the silica content of the silica-alumina support can range from about 2 to about 30 wt. %. The alumina can be any of the aluminas conventionally used for hydroprocessing catalysts. Such aluminas are generally porous amorphous alumina having an average pore size from about 50 to about 200 angstroms. In some embodiments, the oxide supports can also be non-porous oxide materials which have been fused in an electric arc furnace. Representative examples of such non-porous oxide materials include, but are not limited to, fused silica and fused alumina.

The metal oxide catalyst may be in any of the commonly used catalyst shapes such as, for example, spheres, granules, pellets, chips, rings, extrudates, or powders that are well-known in the art.

Suitable reactors for hydrogen production unit 114 include, for example, a slurry reactor, a continuous stirred tank reactor, a fixed bed reactor, or any combination thereof. In some embodiments, the hydrogenation process can be carried out in two hydrogenation reactor units in series. However, the number and type of reactor is not limited and any number and any type of reactor can be used. For example, the hydrogenation process can be carried out in three, four, or more hydrogenation reactor units in series.

In illustrative embodiments, light hydrocarbon feed stream 134 and catalyst are subjected to reaction conditions such as, for example, a temperature of from about 500° C. to about 1200° C., and for a residence time of the light hydrocarbon feed stream 134 in hydrogenation system 102 containing, for example, a fluidized bed reactor, a radial flow reactor or other reactor type, of from about 0.05 seconds to about 100 seconds, or from about 0.1 seconds to about 2 seconds.

In some embodiments, the hydrogen production process is carried out in hydrogen production unit 114 by methane pyrolysis. In some embodiments, the hydrogen production process is carried out in hydrogen production unit 114 by electrified steam methane reforming. In some embodiments, the hydrogen production process is carried out in hydrogen production unit 114 by autothermal reforming of natural gas.

In some embodiments, the hydrogen production process is carried out using heated stream 130 generated in heat production system 124 to provide a portion of the heat necessary to convert light hydrocarbon feed stream 134 to at least hydrogen gas enriched stream effluent 106 in the presence of a catalyst. In some embodiments, the hydrogen production process is carried out using mechanical shaft work and/or electricity 122 to offset mechanical and/or electrical energy obtained from external sources to facilitate the hydrogen production process in hydrogen production unit 114.

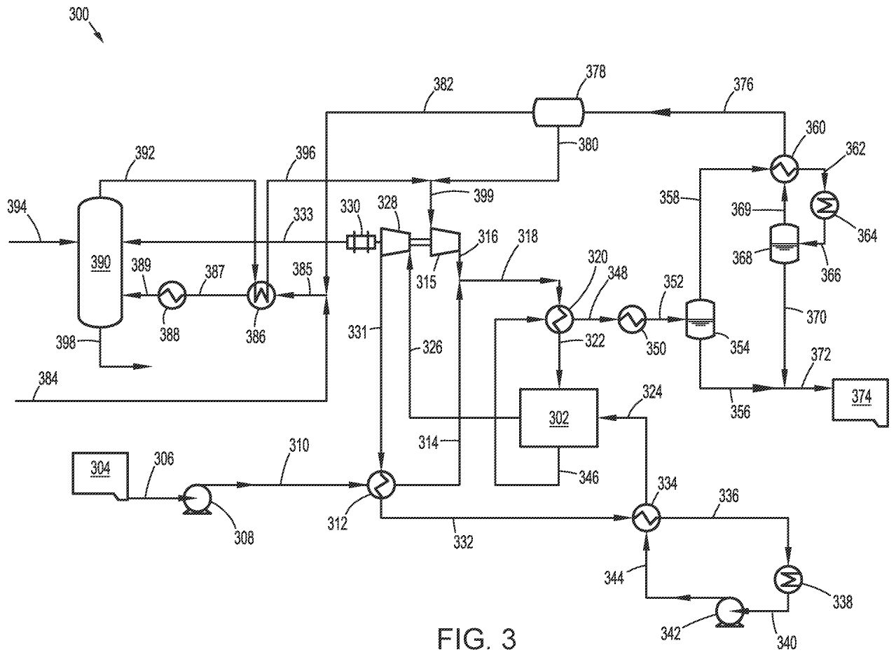

A non-limiting illustrative embodiment of an integrated system and process for producing hydrogen utilizing heat recovered from production of a hydrogen-saturated liquid organic hydrogen carrier in a hydrogen production and transportation value-chain will be described in FIG. 3. It is to be understood that this embodiment is merely illustrative and other integrated systems and processes for producing hydrogen utilizing heat recovered from production of a hydrogen-saturated liquid organic hydrogen carrier in a hydrogen production and transportation value-chain are contemplated.

Referring now to FIG. 3, a system 300 includes a hydrogenation system 302 for receiving a second heated pressurized liquid organic hydrogen carrier and pressurized hydrogen gas enriched stream 322 and an organic Rankine cycle stream 324 as discussed below to hydrogenate the liquid organic hydrogen carrier utilizing the hydrogen gas enriched stream as discussed above. Hydrogenation system 302 produces a hydrogen-saturated liquid organic hydrogen carrier stream 346 and a first heated organic Rankine cycle vapor stream 326. Since hydrogenation system 302 uses an excess of hydrogen to produce hydrogen-saturated liquid organic hydrogen carrier stream 346, hydrogen-saturated liquid organic hydrogen carrier stream 346 will be composed of a liquid phase containing the hydrogen-saturated liquid organic hydrogen carrier in liquid form and a gas phase containing varying amounts of hydrogen gas, unreacted natural gas and some of the hydrogen-saturated liquid organic hydrogen carrier in a vapor phase.

System 300 further includes a liquid organic hydrogen carrier storage tank 304 for storing a liquid organic hydrogen carrier 306. A pump 308 is provided in fluid communication with the liquid organic hydrogen carrier storage tank 304 and a heat exchanger 312. Pump 308 may be a rotary pump including an impeller, or alternatively may be any other suitable fluid pump. In operation, pump 308 receives liquid organic hydrogen carrier 306 having a first pressure and generates a flow of a pressurized liquid organic hydrogen carrier stream 310 having a second pressure greater than the first pressure for flowing to heat exchanger 312. Pump 308 may be powered by, for example, an electric motor.

Heat exchanger 312 receives pressurized liquid organic hydrogen carrier stream 310 and a second heated organic Rankine cycle vapor stream 331 as a heat transfer medium from a turbine 328 discussed below to generate a heated pressurized liquid organic hydrogen carrier 314 and a first cooled organic Rankine cycle vapor stream 332. Second heated organic Rankine cycle vapor stream 331 transfers heat to pressurized liquid organic hydrogen carrier stream 310 having a first temperature and generates heated pressurized liquid organic hydrogen carrier 314 having a second temperature higher than the first temperature. In some embodiments, suitable heat exchangers include, for example, a tube-in-shell, plate-in-frame, microchannel, spiral wound, or any other suitable heat exchanger.

Heated pressurized liquid organic hydrogen carrier 314 is then combined with a pressurized hydrogen gas enriched stream 316 to form a first heated pressurized liquid organic hydrogen carrier and pressurized hydrogen gas enriched stream 318.

System 300 further includes a heat exchanger 320 for receiving first heated pressurized liquid organic hydrogen carrier and pressurized hydrogen gas enriched stream 318 and hydrogen-saturated liquid organic hydrogen carrier stream 346 as a heat transfer medium to generate second heated pressurized liquid organic hydrogen carrier and pressurized hydrogen gas enriched stream 322 and a first cooled hydrogen-saturated liquid organic hydrogen carrier stream 348 having a temperature lower than the temperature of hydrogen-saturated liquid organic hydrogen carrier stream 346. In some embodiments, suitable heat exchangers include, for example, a tube-in-shell, plate-in-frame, microchannel, spiral wound, or any other suitable heat exchanger. Second heated pressurized liquid organic hydrogen carrier and pressurized hydrogen gas enriched stream 322 is then sent to hydrogenation system 302 to undergo hydrogenation in the presence of a catalyst and under hydrogenation conditions as discussed above with regard to FIG. 1 in a continuous loop.

Organic Rankine cycle stream 324 enters hydrogenation system 302 and excess heat generated during the hydrogenation reaction is transferred to produce first heated organic Rankine cycle vapor stream 326. First heated organic Rankine cycle vapor stream 326 is sent to a turbine 328 converted to electrical energy 333 using a shaft driven power generator 330. In general, turbine 328 can only process a portion of first heated organic Rankine cycle vapor stream 326. Thus, second heated organic Rankine cycle vapor stream 331 is recycled back and utilized in heat exchanger 312 and in the organic Rankine cycle process discussed herein.

System 300 further includes an organic Rankine cycle system including a regeneration unit 334, a condenser unit 338 and a pump 342. Regeneration unit 334 can be, for example, a heat exchanger. In some embodiments, a heat exchanger may be a tube-in-shell, plate-in-frame, microchannel, spiral wound, or any other suitable heat exchanger. First cooled organic Rankine cycle vapor stream 332 enters regeneration unit 334 and serves as a heat transfer medium to transfer heat to a pressurized organic Rankine cycle stream 344 operating in the organic Rankine cycle system and to generate organic Rankine cycle stream 324. The organic Rankine cycle stream can be any of the working fluids discussed above with regard to FIG. 2. First cooled organic Rankine cycle vapor stream 332 is likewise cooled by pressurized organic Rankine cycle stream 344 to generate a second cooled organic Rankine cycle vapor stream 336.

Condenser unit 338 is configured to receive second cooled organic Rankine cycle vapor stream 336 that is output from regeneration unit 334, and to cool and condense second cooled organic Rankine cycle vapor stream 336 into a liquid cooled organic Rankine cycle stream 340 through the use of a heat exchanger cooled by, for example, a pressurized seawater stream from a seawater system as discussed above with regard to FIG. 2.

Pump 342 receives liquid cooled organic Rankine cycle stream 340 having a first pressure. Pump 342 can be any suitable pump for increasing the pressure of liquid cooled organic Rankine cycle stream 340 to generate pressurized liquid cooled organic Rankine cycle stream 344 having a second pressure greater than the first pressure. Pressurized liquid cooled organic Rankine cycle stream 344 is then sent to regeneration unit 334 as discussed above.

Turning back to first cooled hydrogen-saturated liquid organic hydrogen carrier stream 348, a heat exchanger 350 is configured to receive first cooled hydrogen-saturated liquid organic hydrogen carrier stream 348 having a first temperature to transfer heat from first cooled hydrogen-saturated liquid organic hydrogen carrier stream 348 to generate a second cooled hydrogen-saturated liquid organic hydrogen carrier stream 352 having a second temperature less than the first temperature.

As discussed above, hydrogen-saturated liquid organic hydrogen carrier stream 346 will be composed of a liquid phase containing the hydrogen-saturated liquid organic hydrogen carrier in liquid form and a gas phase containing varying amounts of hydrogen gas, unreacted natural gas and the hydrogen-saturated liquid organic hydrogen carrier in a gas form. Accordingly, second cooled hydrogen-saturated liquid organic hydrogen carrier stream 352 is sent to a gas-liquid separation unit 354 to separate the liquid phase from the gas phase and generate a liquid hydrogen-saturated liquid organic hydrogen carrier stream 356 and a gas stream 358. As used in this disclosure, a “separation unit refers to any separation device that at least partially separates one or more chemicals in a mixture from one another. For example, a separation unit may selectively separate different chemical species from one another, forming one or more chemical fractions. Examples of separation units include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation. As used in this disclosure, one or more chemical constituents may be “separated” from a process stream to form a new process stream. Generally, a process stream may enter a separation unit and be divided or separated into two or more process streams of desired composition.

Gas stream 358 is then sent to a heat exchanger 360 where it is further cooled by a gas stream 369 containing hydrogen gas and unreacted natural gas as a heat transfer medium. In some embodiments, suitable heat exchangers include, for example, a tube-in-shell, plate-in-frame, microchannel, spiral wound, or any other suitable heat exchanger. A cooled gas phase stream 362 is generated from heat exchanger 360 and sent to a refrigeration source 364 such as a heat pump to liquify the hydrogen-saturated liquid organic hydrogen carrier in gas form to form a stream 366 containing a liquid phase of hydrogen-saturated liquid organic hydrogen carrier and a gas phase of hydrogen gas and unreacted natural gas.

Stream 366 is then sent to a gas-liquid separation unit 368 to separate the liquid phase from the gas phase of stream 366 and to generate a liquid hydrogen-saturated liquid organic hydrogen carrier stream 370 and gas stream 369. Liquid hydrogen-saturated liquid organic hydrogen carrier stream 370 is then combined with liquid hydrogen-saturated liquid organic hydrogen carrier stream 356 to form a liquid hydrogen-saturated liquid organic hydrogen carrier stream 372. Liquid hydrogen-saturated liquid organic hydrogen carrier stream 372 is then sent to a dehydrogenation unit 374 to dehydrogenate liquid hydrogen-saturated liquid organic hydrogen carrier stream 372.

In some embodiments, greater than or equal to about 99 wt. % of liquid hydrogen-saturated liquid organic hydrogen carrier stream 372 is recovered from the hydrogenation process. In some embodiments, greater than or equal to about 99.5 wt. % of liquid hydrogen-saturated liquid organic hydrogen carrier stream 372 is recovered from the hydrogenation process.

As discussed above, gas stream 369 is sent to heat exchanger 360 and generates a cooled gas stream 376 of hydrogen gas and unreacted natural gas. Cooled gas stream 376 is then sent to a membrane separator 378 to separate the hydrogen gas from the unreacted natural gas. In some embodiments, membrane separator 378 has separation efficiency of about 60% to about 90%, or about 70% to 80%. Membrane separator 378 produces first hydrogen gas enriched stream 380 and a natural gas stream 382.

System 300 further includes a natural gas stream 384 which is combined with natural gas stream 382 to form a natural gas stream 385. System 300 further includes a heat exchanger 386 for receiving a hydrogen gas enriched stream 392 from a hydrogen production unit 390 as a heat transfer medium to transfer heat to natural gas stream 385 and generate a first heated natural gas stream 387 and a cooled hydrogen gas enriched stream 396. First heated natural gas stream 387 will have a temperature greater than the temperature of natural gas stream 385. In some embodiments, suitable heat exchangers include, for example, a tube-in-shell, plate-in-frame, microchannel, spiral wound, or any other suitable heat exchanger.

First heated natural gas stream 387 is then sent to a heating unit 388 to raise the temperature of first heated natural gas stream 387 to a suitable hydrogen production processing temperature in hydrogen production unit 390. In some embodiments, heating unit 388 is internal to hydrogen production unit 390. In some embodiments, heating unit 388 is external to hydrogen production unit 390 and includes, for example, natural gas fired heaters, direct electrical resistance heating, heating by electrically generated plasma, or the like. Heating unit 388 produces a second heated natural gas stream 389 having a temperature greater than the temperature of first heated natural gas stream 387.

System 300 further includes hydrogen production unit 390 which is configured to receive second heated natural gas stream 389 to convert second heated natural gas stream 389 to at least hydrogen gas enriched stream 392 and optionally a carbon-based stream 398 in the presence of a catalyst. A suitable catalyst can be any of those discussed above. Hydrogen production unit 390 is further configured to receive electrical energy 333 supplied from shaft driven power generator 330 mechanically coupled to turbine 328 and electrical energy 394 supplied from an external source such as a grid. In some embodiments, electrical energy 333 can supply between about 15% to about 50%, or from about 25% to about 40% of the required electrical heat for the hydrogen production reaction.

Suitable reactors and reaction conditions for hydrogen production unit 390 can be any of those discussed above for hydrogen production unit 114. In some embodiments, the hydrogen production process is carried out in hydrogen production unit 390 by methane pyrolysis. In some embodiments, the hydrogen production process is carried out in hydrogen production unit 390 by electrified steam methane reforming.

As discussed above, hydrogen gas enriched stream 392 is sent to heat exchanger 386 as a heat transfer medium to transfer heat to natural gas stream 385 and generate first heated natural gas stream 387 and cooled hydrogen gas enriched stream 396. Cooled hydrogen gas enriched stream 396 is then combined with first hydrogen gas enriched stream 380 from membrane separator 378 to form a second hydrogen gas enriched stream 399. Second hydrogen gas enriched stream 399 is sent to a compressor 315 to generate pressurized hydrogen gas enriched stream 316 having a pressure greater than the pressure of second hydrogen gas enriched stream 399. Suitable compressors for compressor 315 include, for example, a gas compressor by reciprocating or a centrifugal compressor.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present disclosure and are disclosed herein just as if each and every such sub-combination was individually and explicitly disclosed herein.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A continuous process, comprising:
supplying, to a hydrogen production unit, an energy source in the form of mechanical energy or electrical energy produced from thermal energy generated in a hydrogenation process in a hydrogenation reactor unit; and
flowing a light hydrocarbon feed stream into the hydrogen production unit in the presence of a catalyst under reaction condition to produce a hydrogen gas enriched stream using the energy source.

2. The continuous process according to claim 1, wherein the thermal energy generated in the hydrogenation process is converted to mechanical energy in at least one thermodynamic cycle.

3. The continuous process according to claim 2, wherein the at least one thermodynamic cycle comprises an organic Rankine cycle.

4. The continuous process according to claim 2, further comprising converting the mechanical energy into electric energy with at least one electric generator.

5. The continuous process according to claim 1, wherein the energy source is electrical energy and the electrical energy supplies between about 15% to about 50%, of electrical heat to the hydrogen production unit to produce the hydrogen gas enriched stream.

6. The continuous process according to claim 5, wherein a remaining amount of electrical heat supplied to the hydrogen production unit to produce the hydrogen gas enriched stream is from electrical energy derived from an external source.

7. The continuous process according to claim 1, wherein the hydrogenation process comprises hydrogenating, in the hydrogenation reactor unit, a liquid organic hydrogen carrier to a hydrogen-saturated liquid organic hydrogen carrier in the presence of the hydrogen gas enriched stream and a hydrogenation catalyst.

8. The continuous process according to claim 7, wherein the liquid organic hydrogen carrier is preheated prior to being received in the hydrogenation reactor unit.

9. The continuous process according to claim 7, wherein the light hydrocarbon feed stream is natural gas and the liquid organic hydrogen carrier comprises one of toluene and benzyltoluene.

10. The continuous process according to claim 7, wherein the hydrogenation process is carried out at a temperature of about 400° F. to about 700° F., and a pressure of about 200 to about 1500 psi-g.

11. A continuous process, comprising:
hydrogenating, in a hydrogenation reactor unit, a liquid organic hydrogen carrier to a hydrogen-saturated liquid organic hydrogen carrier in the presence of a first hydrogen gas enriched stream and a hydrogenation catalyst;
converting thermal energy generated in the hydrogenation reactor unit to an energy source in the form of mechanical energy or electrical energy; and
supplying the energy source to a hydrogen production unit to convert a light hydrocarbon feed stream to a second hydrogen gas enriched stream.

12. The continuous process according to claim 11, wherein the thermal energy generated in the hydrogenation reactor unit is converted to mechanical energy in at least one thermodynamic cycle.

13. The continuous process according to claim 12, wherein the at least one thermodynamic cycle comprises an organic Rankine cycle.

14. The continuous process according to claim 13, wherein the converting the thermal energy into mechanical energy comprises powering a turbine with a working fluid in the form of a vapor generated from the organic Rankine cycle.

15. The continuous process according to claim 14, wherein the working fluid is the same as the liquid organic hydrogen carrier or the hydrogen-saturated liquid organic hydrogen carrier.

16. The continuous process according to claim 11, wherein the energy source is electrical energy and the electrical energy supplies between about 15% to about 50%, of electrical heat to the hydrogen production unit to produce the second hydrogen gas enriched stream.

17. The continuous process according to claim 16, wherein a remaining amount of electrical heat supplied to the hydrogen production unit to produce the second hydrogen gas enriched stream is from electrical energy derived from an external source.

18. The continuous process according to claim 11, wherein the light hydrocarbon feed stream is natural gas and the liquid organic hydrogen carrier comprises one of toluene and benzyltoluene.

19. The continuous process according to claim 11, wherein the liquid organic hydrogen carrier is preheated prior to being received in the hydrogenation reactor unit.

20. The continuous process according to claim 11, wherein greater than or equal to about 99.5 wt. % of the hydrogen-saturated liquid organic hydrogen carrier is recovered from the hydrogenating.
